(19) United States
(12) Patent Application Publication
(10) Pub. No.: US 2004/0197548 A1
(43) Pub. Date: Oct. 7, 2004

(54) Method and apparatus for preparing and applying custom color graphic art designs to paved surfaces, and products resulting therefrom

(76) Inventor: Kenneth T. Kopystecki, Pottstown, PA (US)

Correspondence Address: CHARLES N. QUINN, FOX, ROTHCHILD, O'BRIEN & FRANKEL, LLP, 2000 MARKET STREET, 10TH FLOOR, PHILADELPHIA, PA, 19103, US

(21) Appl. No.: 10/804,851

(22) Filed: Mar. 18, 2004

Related U.S. Application Data
(60) Provisional application No. 60/456,140, filed on Mar. 20, 2003.

(51) Int. Cl. B05D 5/10; B32B 18/00

(52) U.S. Cl. 428/325; 427/136

(57) ABSTRACT

The invention is a method of preparing and applying a custom art design to a paved surface. The method comprises preparing a customized art design to be placed on a specific area of pavement by use of photographic manipulation and computer software. Thereafter, a stencil is prepared by routing under the direction of additional software that incorporates the customized art prepared by a customer. Using the prepared stencils, the customized art is applied to the desired surface area. This includes applying a white latex primer/binder coating for the customized art to adhere. Applied to the latex base coat are custom colors using multiple custom stencils, one for each color in the design. Upon drying, a glass beaded clear coat is applied over the full design to give it protection from weather and traffic as well as a non-slip texture.

### CROSS-REFERENCE TO RELATED APPLICATION

This patent application is based on U.S. provisional application serial No. 60/456,140 filed 20 Mar. 2003 in the name of Kenneth T. Kopystecki and entitled “METHODS FOR PREPARING AND APPLYING CUSTOM COLOR GRAPHIC ART DESIGNS TO PAVED SURFACES”, the priority of which is claimed under 35 U.S.C. 119.

### BACKGROUND OF THE INVENTION

1. Field of the Invention

This invention relates to a method for preparing and applying a customized artistic design to asphalt or concrete paved surfaces.

2. Description of the Prior Art

The most common pavement marking technique is line striping; a painted line on pavement that is either straight or curved going from point A to point B. The uses of line striping include wording and/or directional arrows to direct or control the flow of traffic, either pedestrian or motor vehicle; the line striping may be one or more of the primary colors of red, white, blue and yellow, including combinations thereof. The common uses for the primary colors are as follows:

blue—handicaps;

red—fire lanes, stop markers;

yellow or white—for parking space marking in parking lots;

yellow—on highways or roads for lane marking to divide the directions of traffic; and

white—for designation of lanes, and marking the shoulder of roads.

Each color has its own meaning when used as governed by the U.S. Department of Transportation in all towns, municipalities and counties of the United States.

Pavement marking by line striping is not used to bring artistic beauty or style to residential or commercial properties.

Pavement marking using currently available methods is performed in single and separate color applications. These primitively applied markings quickly fade over time due to wear from traffic and weathering problems, thereby creating an “eye-sore”. This discourages markings other than those necessary for traffic flow.

Additionally, due to the aesthetic considerations, problems dealing with safety are an important factor. Paved roads, parking lots or driveways are designed to have a rough surface or textured surface for traction, particularly for pedestrians. This is of critical importance when weather conditions are bad and elements such as snow, ice and rain can accumulate on the pavement surface. The application of line striping at least partially and sometimes completely eliminates the textured surface of a roadway, parking lot or driveway by filling crevices therein. This intensifies the problem of accumulated weather elements on paved surfaces. This also explains why line striping is not applied to steps without some other means of traction, i.e. metal grates.

### SUMMARY OF THE INVENTION

This invention provides a long lasting, colorful, graphic art preparation and application method and apparatus, giving beauty and distinction to all roadways and residential or commercial pavements, while increasing signage and advertising opportunities.

In one of its aspects this invention provides a method for preparing and applying customized art resulting preferably in a non-slip surface pavement where the method includes the steps of preparing the customized art preferably by use of photographic manipulation of the customized art, preparing a plurality of custom stencils to reproduce the customized art to be applied to the paved surface and reproducing the customized art on the paved surface preferably by cleaning the paved surface, applying a primer or binder-based coating to the paved surface for adhesion of the customized art design, applying colors sequentially on to the base coat using a plurality of customized stencils prepared and cut in accordance with pattern defined by the customized art and thereafter preferably applying a clear coating having glass beads therein to provide a non-slip surface on the customized art paved surface.

Preferably, the manipulation of the photographic images includes obtaining a digital image of the paved surface and a surrounding area where the customized art is to be applied, downloading the digital image onto a computer, manipulating art as desired while the art is illustrated with the backdrop of the paved surface and surrounding area where the customized art is to be applied and capturing the completed customized art in digital form.

In the method aspect of the invention, preparation of the custom stencils to produce the artwork includes preferably downloading via suitable media the customized art into a computer attached to a stencil production machine equipped with machining software to read information, including color recognition, from the media and thereafter producing a plurality of custom stencils based on information from the media on said stencil production machine with vacuum preferably being used to hold down the stencil material to be cut by the stencil production machine.

Desirably, the paved area is initially brushed with a wire brush and thereafter an etching solution is applied to enhance adherence of the color to the paved area.

In another one of its aspects, this invention involves apparatus for applying custom color graphic art designs to paved surfaces where the apparatus preferably includes a digital camera, a computer preferably receiving as input the output from the digital camera and including software therein for manipulation, enhancement and change of digital images from the digital camera and further converting the digital images into digital format for input to a numerically controlled flatbed cutting device, where the flatbed cutting device includes means for retaining a sheet of material, from which a stencil is to be cut, against a flat surface and further includes a programmable cutter for cutting the stencil material responsively to input signal received from the computer and manifesting the design of interest, where the apparatus preferably still further includes a tie-down framer receiving the cut stencil material and retaining the stencils against the selected ground surface for manual or machine application of color to the surface through the stencils.

In yet another one of its aspects, this invention provides an aesthetically pleasing paved surface having a multi-color multi-layered sandwich preferably laminated to pavement with a layer contacting the pavement preferably being a bottom background layer preferably of latex and a top layer of the design preferably being clear and preferably having glass beads especially embedded therein in a randomly positioned fashion.

The method of the invention is preferably a multi-step process that can be applied to both old and new surfaces of pavement. The method is preferably initiated by obtaining a digital picture of the area to which the art, i.e. trademark, logo, advertisement, etc., is to be applied and downloading the digital picture preferably onto a laptop computer. The art is preferably introduced to the downloaded digital picture for viewing and manipulation by the customer (preferably on the “laptop” computer) having the backdrop of the area onto which the art is to be applied.

The completed “customized art” is then removed from the “laptop” computer, via 3½ floppy diskette or other usable “hard copy”, and introduced into a computer attached to a stencil production machine. The stencil production machine preferably creates exact duplicates of business logos, product trademarks and icons to be used in the customized art.

The customized art is then applied to the pavement surface. This is preferably initiated by preferably cleaning the paved surface and thereafter preferably applying a white latex primer/binder coating for adhesion. Preferably applied to the latex base coat are custom colors using multiple custom stencils (preferably one for each color in the design) which collectively produce the customized art on the designated surface. Upon drying, a glass beaded clear coat is preferably applied over the top of the full design for protection from weather and traffic. The glass beads covering the customized art are illuminated at night by lights of vehicles or pole lighting. This illumination enhances viewing of the customized art underneath. In addition, the glass beads add a non-slip texture for safety.

There are many uses for the “Pavement Art” produced by the method of the present invention including advertising business establishments and locations on asphalt or concrete pavements with a company or corporate logo, advertising products sold by business establishments, and advertising phone numbers or other business information anywhere there is a paved surface. Opportunities are unlimited at malls, shopping centers, or other business parking lots where one can advertise using pavement art.

It is an objective of the invention to beautify homes and businesses' exterior properties.

Another objective of the invention to allow businesses to advertise easily without having to install traditional signs with posts, hardware, lighting and wiring, all of which are subject to location and size restrictions.

Another objective of the invention is to eliminate labor costs associated with installation of conventional signs and advertising.

Another objective of the invention is to eliminate or reduce the number signs cluttering road sides.

Another objective of the invention is to develop untapped sources of advertising revenue for business and land owners by the sale of additional advertising space.

Another objective of the invention is to provide a method to apply signs which maintain a safe road surface for automobile and pedestrian traffic.

### DETAILED DESCRIPTION OF THE INVENTION

The method of the invention to produce pavement art involves three parts: (1) preparation of customized art by photographic manipulation, (2) preparation of custom stencils, and (3) application of the customized art using the stencils to a paved surface.

Preparation of the customized art by photographic manipulation is preferably accomplished by obtaining a digital image of the surface (preferably including the surrounding area), of where the art (i.e. logo, advertisement or trademark) is to be applied, captured by a digital camera. This image can preferably be obtained using any commercially available digital camera supporting smart media card and flash path card software. Thereafter, the recorded digital image is preferably downloaded to a laptop computer having commercially available software, i.e. a paint program. The paint program allows edits and artistic manipulation of the captured image and superimposing of art. The user may customize the art, producing customized art, as desired with a backdrop of the surface and surrounding area of pavement where the art is to be applied.

The software containing the completed customized art is removed from the laptop computer and introduced via a 3 and ½ inch floppy diskette or other usable media or hard copy into a computer which may be connected to a stencil production machine. This computer is equipped with 3-dimensional machinists software which reads the information, including color recognition, from an installed 3 and ½ diskette or other usable hard copy.

The commercially available Enroute III software, manufactured by Scanbecamiable, Inc. (Philadelphia, Pa.), may be used for this purpose. This software “vectorizes” or transforms the picture into “lines” each having a particular defined parameter. The vectorized image is then transferred via the CNC interface installed in the stencil production machine for creation of the stencils which are used when applying the customized art to the designated surface. The stencils are custom made, based on the information on the 3 and ½ diskette, on a CNC 4′×8′ flatbed router with vacuum hold down in the stencil production machine, a suitable one of which is manufactured by Techno, Inc. The prepared stencils are preferably made of a lightweight plastic, e.g. light density polyethylene (LDPE).

One stencil is prepared for each color in the customized art. For example, if a customized art design of an American flag is to be placed on a paved area, three (3) stencils are prepared; one for red, one for white and one for the blue area of the flag.

The customized art is applied to the asphalt or concrete pavements preferably in a four (4) step process.

The process involved in applying the customized art to the designated surface preferably begins with cleaning the asphalt or concrete surface. If the surface is asphalt, cleaning can be accomplished by etching the surface with a commercially available product. Alternatively, if the surface is concrete, better results are obtained if the surface is cleaned using a wire broom and thereafter applying a commercially available sealer. Upon completion of the cleaning process and elapse of any necessary drying time, a preferably white latex primer/binder coating is applied for adhesion of the customized art. Any suitable commercially available latex primer, i.e. H & C primer, may be used. This primer is preferably applied at least one-half inch larger in perimeter than the customized art being applied to the surface.

Thereafter, the custom colors are preferably applied onto the base coat preferably using the multiple custom stencils prepared exclusively for a particular customized art design. Each color in the design is preferably applied individually, using the prepared stencils. The colors can be applied in latex paint or spread by brush or commercially available paint spraying device.

When the colors are completely dry, a clear coating is preferably applied. While the clear coating is still wet, a thin layer of glass beads is preferably applied to give an anti-slip texture. The glass beaded clear coat over the top of the full design is preferably applied for protection from weather and traffic. The glass beads covering the customized art are illuminated at night by the lights of vehicles or pole lighting. This illumination enhances viewing of the customized art underneath. In addition, the glass beads impart a non-slip texture to the surface of the paved area for safety.

The following is claimed:

1. A method for preparing and applying customized art having a non-slip surface to a paved surface comprising the steps of:
a. preparing said customized art by use of photographic manipulation, wherein said customized art is captured on hard copy;
b. preparing a plurality of custom stencils to reproduce said customized art to be applied to said paved surface; and
c. applying said customized art to said paved surface by:
i. cleaning said paved surface;
ii. applying to said paved surface a primer/binder base coating for adhesion of said customized art design;
iii. applying custom colors onto said base coat using said plurality of custom stencils prepared to reproduce said customized art; and
iv. applying a clear coating having glass beads therein.

2. The method of claim 1, wherein said preparation of said customized art by use of photographic manipulation includes the steps of:
a. obtaining a digital image of said paved surface and surrounding area of where said customized art is to be applied;
b. downloading said digital image to a laptop computer;
c. manipulating art as desired by the customer, while said art is illustrated with a backdrop of said paved surface and surrounding area where said customized art is to be applied; and
d. capturing the completed customized art on said hard copy.

3. The method of claim 2, wherein said preparation of custom stencils comprises the steps of:
a. downloading via said hard copy said customized art into a second computer attached to a stencil production machine equipped with a 3-D machinists software which will read information, including color recognition, on said hard copy;
b. producing said plurality of custom stencils based on said information on said hard copy on a router with vacuum hold down of said stencil production machine.

4. The method of claim 1, wherein said cleaning of said paved surface comprises the steps of:
a. brushing said paved area with a wire brush; and
b. applying an etching solution.

5. The method of claim 3, wherein said hard copy is a 3 and ½ inch diskette.

6. Apparatus for applying custom color graphic art design to pavement surfaces comprising:
a. a digital camera;
b. a computer receiving as input the output from said digital camera and including software therein for manipulation, enhancement and changing of digital images from said digital camera and further converting said digital images into format for input to a numerically controlled flatbed router;
c. said flatbed router including means for retaining a sheet of material from which a stencil is to be cut against a flat surface and further including a programmable cutter for cutting said material responsively to input signal received from said computer;
d. a tied down framer receiving said cut stencil materials from said router and retaining said stencils against a selected ground surface for manual or machine application of color to said surface through said stencils.

7. An aesthetically pleasing paved surface comprising a multi-color multi-layer design sandwich laminated to pavement with a layer contacting said pavement being a bottom background layer of latex and a top layer of said design being a clear layer having glass beads partially embedded therein in a randomly positioned fashion.
